(19) United States
(12) Patent Application Publication
(10) Pub. No.: US 2006/0027683 A1
(43) Pub. Date: Feb. 9, 2006

(54) Application head

(76) Inventor: Marcel Puffe, Sankt Augustin (DE)

Correspondence Address: Robert P. Renke, Suite 250, 28333 Telegraph Road, Southfield, MI, 48034, US

(21) Appl. No.: 10/911,301

(22) Filed: Aug. 4, 2004

(51) Int. Cl. B05B 1/30

(52) U.S. Cl. 239/581.1; 239/569

(57) ABSTRACT

An application head for applying a liquid medium, such as a hot melt adhesive or cold glue, to a substrate. The application head includes a housing (2) which forms a chamber (3) which is rotation-symmetric relative to an axis of rotation (A) and comprises a supply channel (4) and an outlet aperture (5) at one end, as well as a rotatingly attached control slide (6) which is supported so as to be rotatable around the axis of rotation (A). The control slide (6) which is positioned at an end face in the chamber (3) and closes same comprises at least one passage (15) to allow the through-flow of the adhesive medium from the chamber (3) into the outlet aperture (5).

### TECHNICAL FIELD

The invention relates to an application head for applying a liquid medium, for example a hot melt adhesive, to a substrate. The application head has a housing with a chamber with a supply channel and an outlet aperture. Application heads of this type are used especially for intermittently applying the liquid, such as an adhesive medium, in the form of points or “lines” to a length of material guided past the application head.

### BACKGROUND OF THE INVENTION

U.S. Pat. No. 6,024,299 proposes an application head having a control element with a through-channel and a rotatingly drivable control slide. The through-channel is connected to a supply channel for melted hot melt adhesive at the input end and with a nozzle aperture for the melted hot melt adhesive at the output end. In the course of one 360° rotation, the control slide opens and closes the through-channel at least once.

From DE 197 48 908 C1 there is known an application head for liquid media, which comprises a nozzle needle which is axially displaceably supported in the chamber and which passes freely through the chamber. The nozzle needle leaves the chamber and, by means of its point, is placed on a nozzle needle seat of the outlet nozzle. At its end opposed to the nozzle needle seat, the nozzle needle is connected to an actuating device which serves to axially displace the nozzle needle. An oscillating movement of the nozzle needle causes the outlet nozzle to be alternately opened and closed, so that the liquid medium is intermittently applied to a medium guided past the application head.

Both of the foregoing designs have drawbacks in that they either lack a robust design necessary for long service life or are incapable of relatively high application speeds. Thus, there exists a need for an improved application head design.

### SUMMARY OF THE INVENTION

The present invention provides an application head for liquid media, which, more particularly when applied intermittently, ensures a long service life and a high application speed at the same time.

In accordance with one embodiment of the invention, an application head for applying a liquid medium, for example a hot melt adhesive or cold glue, to a substrate is disclosed. The application head comprises a housing which forms a chamber which is rotation-symmetric relative to an axis of rotation (A), and is provided with a supply channel into the chamber and an outlet aperture at an end face of the chamber. The head further includes a rotatingly drivable control slide which is rotatably supported around the axis of rotation and which is positioned at the end face of the chamber and closes same and which has at least one passage to allow liquid, more particularly adhesive medium to flow from the chamber into the outlet aperture.

Because the control slide is rotatingly drivable and comprises at least one passage for the highly viscous medium, the outlet aperture, in the course of one 360° rotation of the control slide, is opened and closed at least once. The present embodiment is particularly advantageous in that in the chamber which, at one end, contains the control slide, there is built up a pressure, so that, with the outlet aperture overlapping with the passage, the liquid medium is pressed under pressure out of the outlet aperture. In this way, more particularly if the medium is applied intermittently, it is possible to produce a caterpillar-shaped application pattern.

According to another embodiment, the outlet aperture and the at least one passage are arranged so as to extend axis-parallel relative to the axis of rotation. This design makes it possible to circumferentially distribute a number of passages in the control slide.

The control slide can comprise a plurality of passages which, more particularly, extend over differently sized arched portions around the axis of rotation. In this way, for 360° rotation of the control slide, several points of glue can be applied, with the points of glue being permitted to have different lengths. According to a further embodiment, a plurality of passages are provided which each comprise the same distance from the respective adjoining passage. This embodiment produces a glued seam with a uniform application pattern.

According to a further embodiment of the invention, the control slide comprises a pressure face which delimits the inner space of the chamber towards the outlet aperture and which can be subjected to load by the liquid medium entering the chamber. By pressurizing the pressure face of the control slide, the latter is pressed against the base of the chamber, as a result of which a gap formed as a result of production inaccuracies between the control slide and the base is kept small. The pressure face of the control face can be annular or circular in shape and approximately corresponds to a cross-sectional face of the chamber, which face extends perpendicularly relative to the axis of rotation. In this way, liquid medium is prevented from passing through a gap between the control slide and a side wall of the housing and through the outlet aperture.

According to yet another embodiment, the housing comprises a cover and a base, wherein a shaft of the control slide is supported in the cover and wherein the control slide rests on the base. The control slide can include a bearing journal which is supported on the axis of rotation in a bearing bore in the base of the housing. By supporting the control slide above and below the chamber, the bending moment in the control slide is low.

According to a still further embodiment, the control slide comprises a control face in the shape of a spherical portion which rests on a corresponding hollow spherical portion of the chamber. According to an alternative embodiment, the control slide comprises a conical control face which rests on a corresponding hollow conical base of the chamber. According to a further alternative, the control is disc-shaped and rests on the planar base of the chamber. The at least one passage can be provided in the shape of an outwardly open round broken out portion. Through said round broken-out portion, the liquid medium leaves the chamber, with the control slide being in a corresponding rotational position.

According to yet another embodiment, the control slide comprises an inner channel with an entrance and an exit to allow the passage of compressed air, wherein the entrance is permanently pressurized by compressed air and wherein, in a rotational position of the control slide, the exit is connected to the outlet aperture. When the outlet aperture of the channel overlaps with the outlet aperture of the housing, any residue of the liquid medium can be pressed out of the outlet aperture and outlet nozzle by the compressed air. In this way, it is possible to produce a clean and uniform glued seam.

According to a further solution for achieving a robust and high speed application head, there is provided an application head for applying a liquid medium, for example a hot melt adhesive or cold glue, to a substrate, comprising a housing which forms a chamber which is rotation-symmetric relative to an axis of rotation and is provided with a supply channel and an outlet aperture at an end face of the chamber. The head further includes a rotatingly drivable control side which is rotatably supported around the axis of rotation in the chamber, and which comprises at least one passage to allow the liquid medium to flow from the supply channel to the outlet aperture, and which directly adjoins the supply channel of the housing. This embodiment, too, is advantageous in that it ensures a long service life and a high application speed due to the rotatingly drivable control slide.

According to one embodiment, the end of the control slide which faces the base has the shape of a spherical portion and is adapted to the correspondingly shaped hollow spherical base of the housing. The outlet aperture of the housing and the mouth of the at least one passage are arranged on the axis of rotation. According to a further embodiment, the supply channel is arranged in a side wall of the housing and the inlet of the passage is arranged in the circumferential face of the control slide.

Other advantages and features of the invention will become apparent to one of skill in the art upon reading the following detailed description with reference to the drawings illustrating features of the invention by way of example.

### BRIEF DESCRIPTION OF THE DRAWINGS

For a more complete understanding of this invention, reference should now be made to the embodiments illustrated in greater detail in the accompanying drawings and described below by way of examples of the invention.

In the drawings:

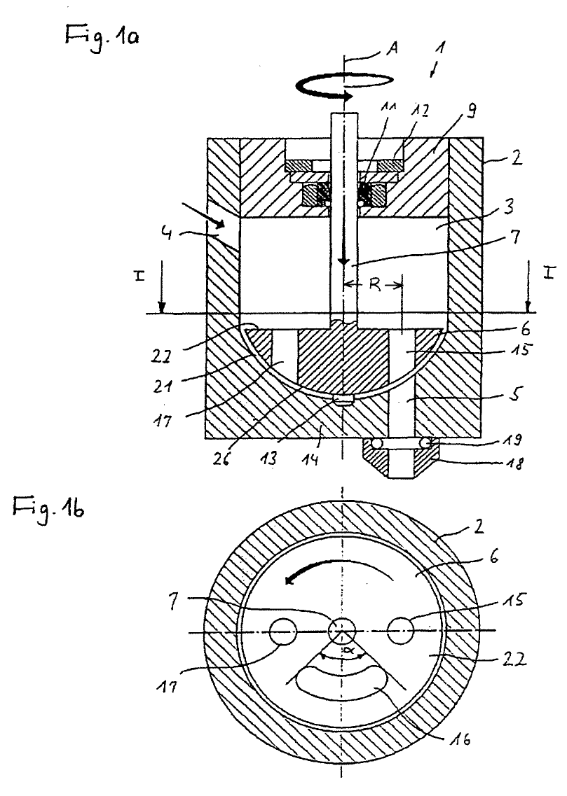

FIG. 1 shows a first embodiment of an application head:
A) in a longitudinal section; and
B) in a cross-section along sectional line I-I in FIG. 1A.

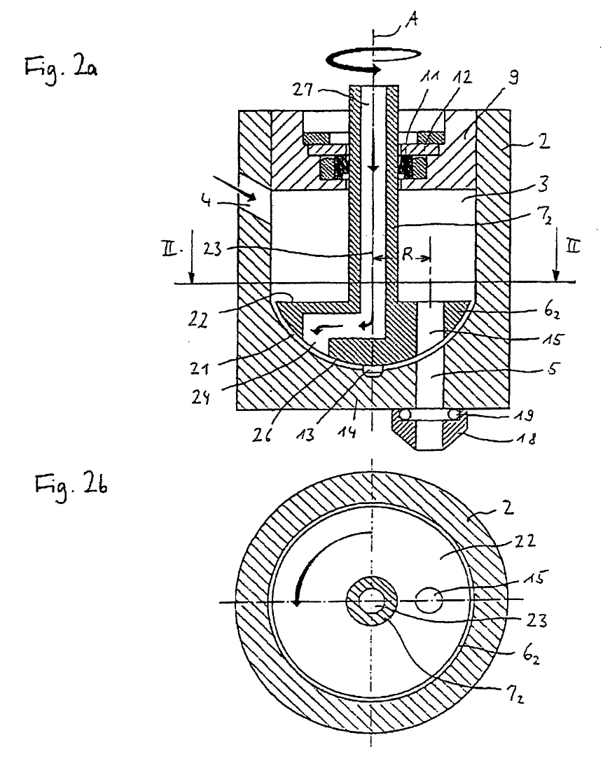

FIG. 2 shows a variant of the application head according to FIG. 1:
A) in a longitudinal section; and
B) in cross-section along sectional line II-II of FIG. 2A.

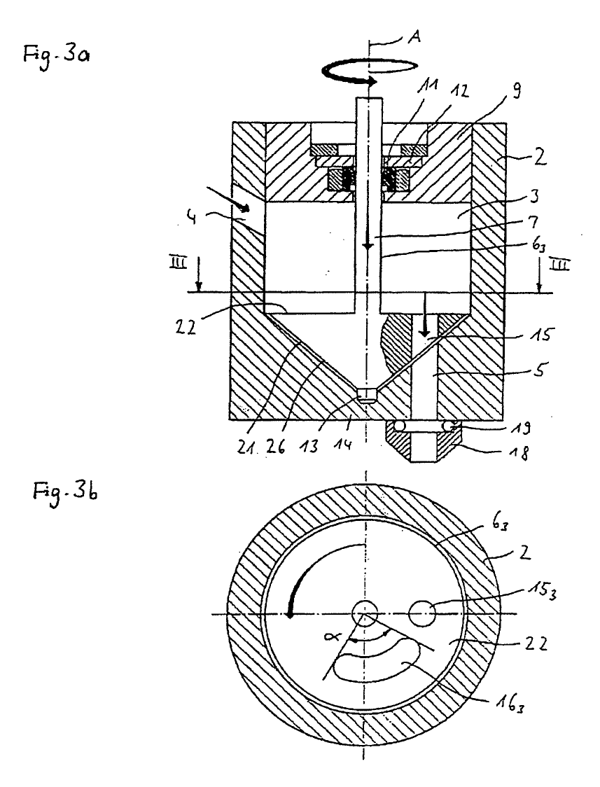

FIG. 3 shows a second embodiment of an application head:
A) in a longitudinal section; and
B) in cross-section along sectional line III-III of FIG. 3A.

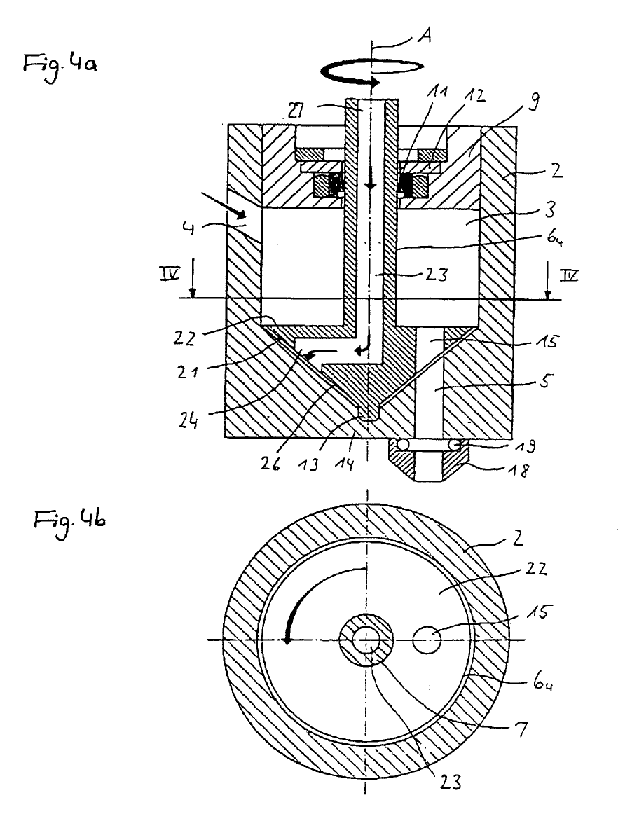

FIG. 4 shows a variant of the application head according to FIG. 3:
A) in a longitudinal section; and
B) in cross-section according to sectional line IV-IV of FIG. 4A.

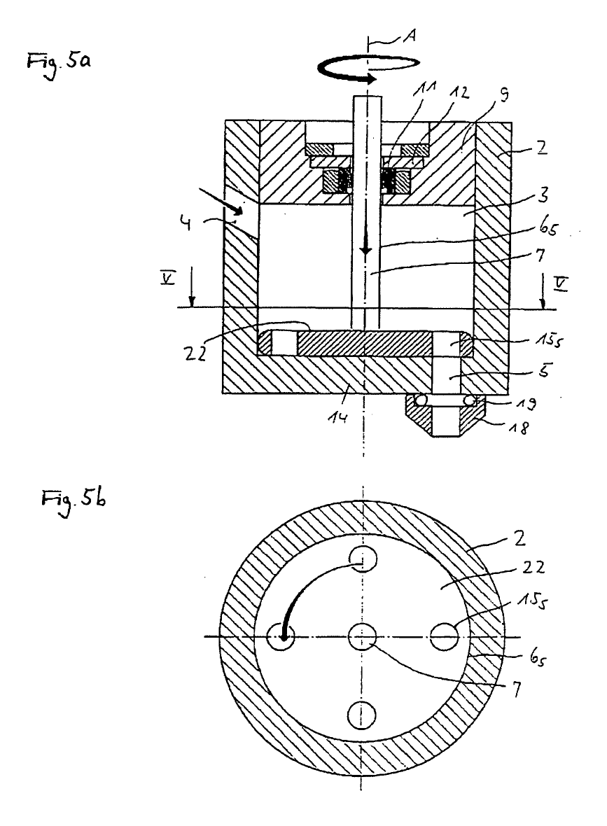

FIG. 5 shows a third embodiment of an application head:
A) in a longitudinal section; and
B) in cross-section according to line V-V of FIG. 5A.

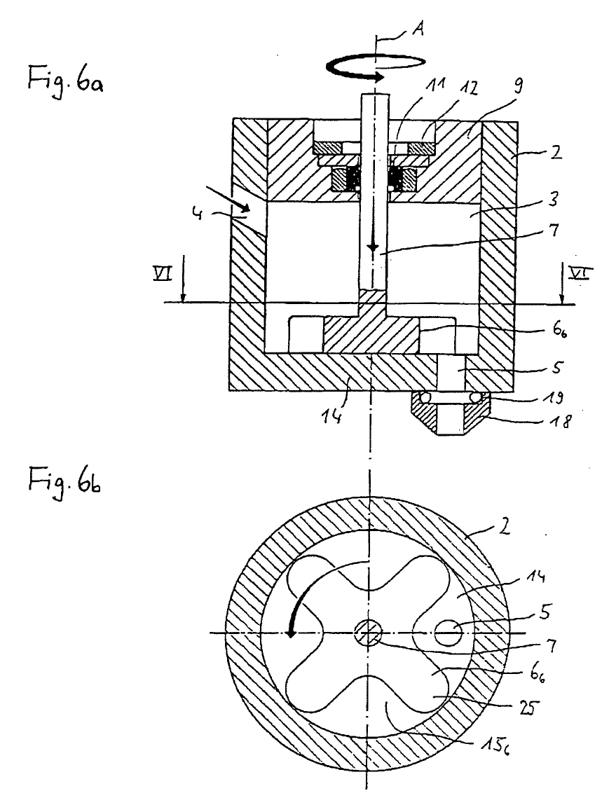

FIG. 6 shows a fourth embodiment of an application head:
A) in a longitudinal section; and
B) in cross-section according to sectional line VI-VI of FIG. 6A.

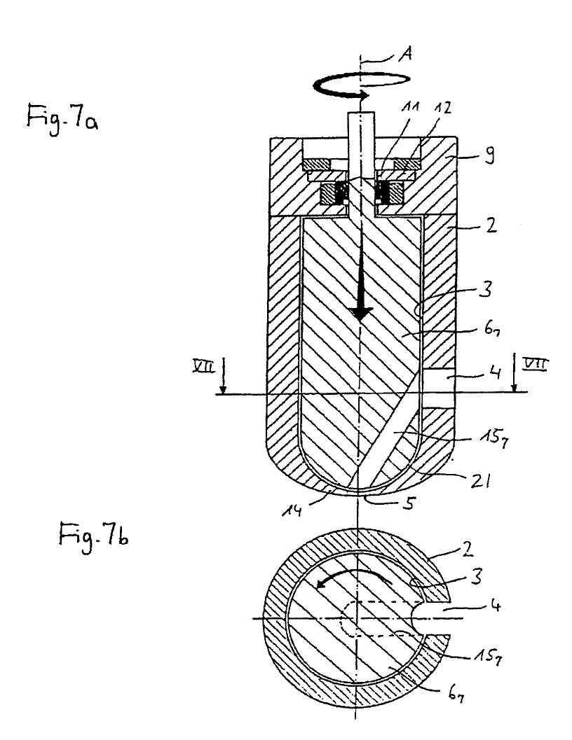

FIG. 7 shows a fifth embodiment of an application head:
A) in a longitudinal section; and
B) in cross-section along sectional line VII-VII of FIG. 7A.

### DETAILED DESCRIPTION OF THE DRAWINGS

While the present invention is described with respect to an apparatus for the application of hot melt or cold adhesives, the invention may be adapted and utilized for applying numerous viscous substances in either an intermittent or continuous bead. These may include, for example, lubricants, sealants or adhesives.

In the following description, various operating parameters and components are described for several embodiments. These specific components and parameters are included as examples and are not meant to be limiting.

Referring now to the drawings wherein like reference numerals are used to identify similar components in the various views. FIGS. 1A and 1B illustrate a first embodiment of an application head according to the invention. FIGS. 1A and 1B which will be described jointly below show an application head 1 with a housing 2 which comprises a chamber 3 with a supply channel 4 and an outlet aperture 5, as well as a control slide 6. The control slide 6 is rotatably supported in the chamber 3 and comprises a shaft 7 which passes through the chamber 3. The housing 2 is dish-shaped and comprises a cover 9 closing the top end of the housing, and a base 14. In the cover 9 there is provided a bearing 11 which rotatably holds the shaft 7 of the control slide 6. The bearing 11 is axially firmly held by a securing ring 12 in the cover 9. At its base end, the control slide 6 comprises a bearing journal 13 which, for supporting purposes, is positioned in a corresponding bearing bore in the base 14 of the housing 2.

The control slide 6 has the shape of a spherical portion, with the shape of the control slide 6 being adapted to the contour of the hollow spherical inner face of the wall of the housing 2, which wall forms the base 14. Between a control face 26 of the control slide 6 and the base 14 there is formed a gap 21 as a result of production tolerances. At its end facing the supply channel 4, the control slide 6 comprises a planar pressure face 22 whose cross-section corresponds to the cross-section of the chamber 3. A highly viscous medium, such as a hot melt adhesive or cold glue, flowing into the chamber 3 through the supply channel 4 generates an excess pressure in the chamber 3, so that the pressure face 22 of the control slide 6 is pressurised towards the base 14 of the housing 2. This is indicated by the arrow on the shaft 7 pointing towards the base 14. In the control slide 6, there is provided first and third passages 15, 17 in the form of bores as well as a second passage 16 arranged therebetween in the form of an oblong hole. The second passage 16 extends along a larger arched cross-section spanning an angle (a) around the axis of rotation (A) as compared to the first and third passages 15, 17.

The passages 15, 16, 17 extend through the height of the control slide 6 at a constant distance (R) parallel to the axis of rotation (A) and connect the chamber 3 to the outlet aperture 5 of the housing 2. In this way—when the control slide 6 is in a rotational position in which one of the passages 15, 16, 17 overlaps with the outlet aperture 5—adhesive is pressed out of the chamber 3 through the respective passage and through the outlet aperture 5 from the application head 1. In the direction of flow, at the end of the outlet aperture 5, there is provided an outlet nozzle 18 at the housing 2 through which the adhesive emerges. The outlet nozzle 18 is sealed relative to the housing 2 by means of a sealing ring 19. The present embodiment comprising a plurality of passages distributed around the circumference of the control slide 6 ensures an intermittent application of the glue in the form of points or lines (sometimes referred to as “caterpillars”) positioned between two points to a length of material passing the application head. The length of the lines applied can be set and varied by the rotational speed of the control slide. In the case of applications wherein a continuous application of adhesive takes place, the control slide is moved into a position in which one of the first or third passages 15, 17 overlaps with the outlet aperture 5. If, over a certain distance, the application of adhesive is to be interrupted, the control slide 6 can be rotated into a position in which the control slide 8 covers the outlet aperture 5.

FIGS. 2A and 2B shows a variant of an application head according to FIG. 1 in a longitudinal section and in a cross-section, with the design substantially corresponding to the design of the application head according to FIG. 1. To that extent, reference is made to the above description. Identical components have been given the same reference numbers. Any components that differ have been given reference numbers with the subscript “2”. The present application head 1 differs from the application head according to FIG. 1 in that it comprises a control slide 62 with a channel 23 which serves to guide compressed air through the outlet aperture 5. The channel 23 extends from the entrance 27 in the direction of flow of the compressed air initially on the axis of rotation (A) centered by the shaft 7₂ towards the lower portion of the control slide 6₂ where it extends radially away from the axis of rotation (A) on a radius corresponding to the distance (R) between the outlet aperture 5 and the axis of rotation (A), and ends in the exit 24.

The control slide 6₂ can thus be transferred into a rotational position in which the exit 24 of the channel 23 and the outlet aperture 5 of the housing overlap. In this way, any residue of the adhesive can be cleared or “shot” out of the outlet aperture 5 and the outlet nozzle 18. This embodiment is advantageous in that, with an intermittently operating application head where adhesive is applied in the form of points or lines, the adhesive is applied accurately and that no adhesive threads are drawn between two application points. As is particularly evident from FIG. 2B, there is provided only a passage 15 which is offset relative to the exit 24 of the channel 23 by 180° around the axis of rotation A. As a result of the rotation of the control slide 6₂, points and caterpillars of adhesive respectively are applied to a length of material passing the application head, wherein one rotational position in which the hot melt adhesive is pressed through the outlet aperture 5 and the outlet nozzle 18 alternates with a rotational position in which the outlet aperture 5 and the outlet nozzle 18 are blown free by the air flowing through the channel 23. In this way it is possible to achieve a very clean seam of adhesive.

FIGS. 3A and 3B show a second embodiment of an inventive application head which substantially corresponds to that shown in FIG. 1. To that extent, reference is made to the above description. Identical components have been given the same reference numbers. Any components which differ have been provided with reference numbers with the subscript “3”. In accordance with the present embodiment, the control slide 6₃ is conical in shape and, accordingly, the wall of the housing 2, which wall closes the chamber 3 towards the base 14 has a hollow conical shape. This embodiment is advantageous relative to that of FIG. 1 in that it is easier to produce. Between the conical control slide 6₃ and the wall of the housing 2, there is formed a gap 21. The control slide 6₃ comprises a first passage 15₃ and an oblong second passage 16₃ which adjoins in the direction of rotation of the control slide 6₃. As a result of this design, with a rotating control slide, it is possible to produce a glued seam on a material passing the application head, with the adhesive points and adhesive lines alternating and with the distance between an adhesive point and an adhesive line corresponding to the ratio of division of the arched portions between the first passage 15₃ and the second passage 16₃ over a full rotation of the control slide.

The application head according to FIGS. 4A and 4B shows a variant of the application head in FIG. 3, having a channel 23 for passing through compressed air, with the design substantially corresponding to the application head according to FIG. 2. To that extent reference is made to the above description. Identical components have been given the same reference numbers and any components which differ have been provided with reference numbers with the subscript “4”. The present application head 1 differs from the application head according to FIG. 3 in that it comprises a control slide 6₄ with a channel 23 with an entrance 27 and an exit 24 which serves to pass compressed air through the outlet aperture 5. In a rotational position of the control slide 6₄ in which the exit 24 of the channel 23 overlaps with the outlet aperture 5 of the housing, any residue of the adhesive can be pressed by compressed air out of the outlet aperture 5 and the outlet nozzle 18, as a result of which there are obtained the above-mentioned advantages.

FIGS. 5A and 5B show a further embodiment of an inventive application head with a housing 2 which forms a cylindrical chamber 3, and with a disc-shaped control slide 6₅. Otherwise, the embodiment shown substantially corresponds to the application head according to FIG. 1 to the description of which reference is made to that extent. The disc-shaped control slide 6₅ comprises four uniformly circumferentially distributed passages 15₅ which, with a rotating control slide 6₅, permit an intermittent outflow of adhesive out of the chamber 3 through the outlet aperture 5 and the outlet nozzle 18. Because the passages 15₅ are uniformly circumferentially distributed, it is possible—with a constant rotational speed of the control slide—to produce a glued seam whose points of glue are arranged at identical distances from one another.

In the embodiment according to FIGS. 6A and 6B which largely corresponds to the application head according to FIG. 5, the control slide 6₆ comprises four radial arms 25, so that the passages 15₆ formed between each two arms are provided in the form of edge recesses. In a rotational position in which none of the arms 25 covers the outlet aperture 5, the chamber 3 is directly connected to the outlet aperture, so that the adhesive can freely move out of the application head through the outlet nozzle 18. The control slide 6₆ rests on the base 14 of the housing 2.

A further embodiment is shown in FIGS. 7A and 7B. They show an application head with a substantially cylindrical housing 2 which comprises a chamber 3 with a supply channel 4 and an outlet aperture 5 in which the control slide 6₇ is positioned so as to be rotatable around its axis of rotation (A). The supply channel 4 is arranged in a side wall of the housing 2 and, in the illustrated rotational position of the control slide 6₇, ends in a passage 15₇ of the control slide 6₇. The passage 15₇ extends from the supply channel 4 towards the end facing the base 14 of the housing 2 and ends on the axis of rotation (A) in the outlet aperture 5 of the housing 2. As in the embodiment according to FIG. 1, to the description of which reference is hereby made to that extent, the end of the control slide 6₇ has the shape of a spherical portion and is adapted to the hollow spherical inner face of the wall of the housing 2, which wall forms the base 14. Between the control face 26 of the control slide 6₇ and the base 14, there is formed a gap 21. To prevent the adhesive from entering said gap 21 and pushing the control slide 6₇ away from the base 14, the control slide 6₇ is pressurised towards the base 14 of the housing, which is indicated by the downward arrow.

When the application head is in operation, the control slide 6₇ rotates around the axis of rotation (A), so that, when the control slide 6₇ with its passage 15₇ is positioned in one sectional plane together with the supply channel 4, adhesive can be applied from an attaching piece (not shown) connectable to the housing through the supply channel 4 and the passage 15₇ towards the outlet aperture 5 to a material or substrate (not shown) which is guided past the application head 1. In the remaining rotational positions, the connection between the supply channel 4 and the outlet aperture 5 is interrupted by the control slide 67, so that no adhesive can be applied. By rotating the control slide 6₇ there is thus produced a glued seam which consists of glued points adjoining one another. The length of the points or lines applied can be varied by the rotational speed of the control slide 6₇. In the case of applications where a continuous application of glue is required, the control slide 6₇ is moved into a position in which the passage 15₇ is positioned in one sectional plane together with the supply channel 4, the advantage of this embodiment being that the outlet aperture 5 is arranged centrally on the axis of rotation (A) which, at the same time, constitutes the axis of symmetry of the application head, thus permitting accurate positioning and accurate application of the glue. Because a chamber is eliminated, the size of the application head can be kept small.

From the foregoing, it can be seen that there has been brought to the art a new and improved application head for a liquid medium. While the invention has been described in connection with one or more embodiments, it should be understood that the invention is not limited to those embodiments. Thus, the invention covers all alternatives, modifications, and equivalents as may be included within the spirit and scope of the appended claims.

What is claimed is:

1. An application head for applying a liquid medium to a substrate, comprising:
a housing defining a chamber which is rotation-symmetric relative to an axis of rotation (A), the housing including a supply channel into the chamber and an outlet aperture at an end face of the chamber; and
a rotatingly drivable control slide which is rotatably supported around the axis of rotation (A) and which is positioned at the end face of the chamber and closes same and which has at least one passage to allow liquid medium to flow from the chamber into the outlet aperture.

2. An application head according to claim 1, wherein the outlet aperture and the at least one passage are arranged axis-parallel relative to the axis of rotation (A).

3. An application head according to claim 1, wherein the control slide comprises a plurality of passages at least one of which extends over differently sized arched portions (a) around the axis of rotation (A).

4. An application head according to claim 1 comprising a plurality of passages each equally circumferentially spaced from the respective adjoining passage.

5. An application head according to claim 1, wherein the control slide comprises a pressure face which delimits an inner space of the chamber towards the outlet aperture and which can be subjected to load by the liquid medium entering the chamber.

6. An application head according to claim 5, wherein the pressure face of the control slide has an annular or circular shape and approximately corresponds to a cross-sectional shape of the chamber which extends perpendicularly relative to the axis of rotation (A).

7. An application head according to claim 1, wherein the housing comprises a cover and a base, and wherein a shaft of the control slide is supported in the cover and wherein the control slide rests on the base.

8. An application head according to claim 7, wherein the control slide comprises a bearing journal which is supported on the axis of rotation (A) in a bearing bore in the base of the housing.

9. An application head according to claim 1, wherein the control slide comprises a control face in the shape of a spherical portion which rests on a corresponding hollow spherical base of the chamber.

10. An application head according to claim 1, wherein the control slide comprises a conical control face which rests on a corresponding hollow conical base of the chamber.

11. An application head according to claim 1, wherein the control slide is disc-shaped and rests on a base of the chamber.

12. An application head according to claim 1, wherein at least one passage is provided in the shape of an outwardly open, broken-out edge portion.

13. An application head according to claim 1, wherein the control slide comprises an inner channel with an entrance and an exit to allow the passage of compressed air, wherein the entrance can be pressurized by compressed air and wherein, in a rotational position of the control slide, the exit is connected to the outlet aperture.

14. An application head according to claim 13, wherein the channel extends through the shaft of the control slide.

15. An application head for applying a liquid medium to a substrate, comprising:
a housing defining a chamber which is rotation-symmetric relative to an axis of rotation (A), the housing including a supply channel and an outlet aperture at an end face of the chamber; and
a rotatingly drivable control slide which is rotatably supported around the axis of rotation (A) in the chamber, which comprises at least one passage to allow the liquid medium to flow from the supply channel to the outlet aperture, and which directly adjoins the supply channel of the housing.

16. An application head according to claim 15, wherein an end of the control side is correspondingly shaped to a hollow spherical base of the housing.

17. An application head according to claim 15, wherein the outlet aperture, the housing, and a mouth of the at least one passage are arranged on the axis of rotation (A).

18. An application head according to claim 15, wherein the supply channel is arranged in a side wall of the housing and that the inlet of the passage is arranged in a circumferential face of the control slide.

19. An application head for applying a liquid medium to a substrate, comprising:
a housing defining a chamber which is rotation-symmetric relative to an axis of rotation (A), the housing including a supply channel into the chamber and an outlet aperture at an end face of the chamber; and
a rotatingly drivable control slide which is rotatably supported around the axis of rotation (A) and which is positioned at the end face of the chamber and closes same and which has at least one passage to allow liquid medium to flow from the chamber into the outlet aperture,
the control slide comprising a control face correspondingly shaped to a hollow base of the housing, and a pressure face delimiting an inner space of the chamber towards the outlet aperture and which can be subjected to load by the liquid medium to substantially sealingly engage the control face to the hollow base of the housing.

20. An application head according to claim 19, wherein the control face is at least one of spherical, conical or disc-shaped.
